(19) United States
(12) Patent Application Publication
(10) Pub. No.: US 2010/0071065 A1
(43) Pub. Date: Mar. 18, 2010

(54) INFILTRATION OF MALWARE COMMUNICATIONS

(75) Inventors: Faud A. Khan, Osgoode (CA); Stanley T. Chow, Ottawa (CA); Bassem Abdel-Aziz, Kanata (CA)

Correspondence Address: GARLICK, HARRISON & MARKISON (ALU), P.O. BOX 160727, AUSTIN, TX, 78716-0727, US

(73) Assignee: ALCATEL LUCENT, PARIS (FR)

(21) Appl. No.: 12/233,512

(22) Filed: Sep. 18, 2008

(51) Int. Cl. G06F 21/00

(52) U.S. Cl. 726/24

(57) ABSTRACT

Infiltration of malware communications. Malicious programs infecting individual devices within a network oftentimes communicate with another infected device (e.g., a master device by which the infection was established on a slave device in the first place). During this call home to a master device (or receiving a call from the master device), vital information about the attack, target, master device, etc. may be transmitted. The call home may include information acquired/retrieved from the infected device, or it may request additional information from the infecting device. By monitoring the network messages associated with such call home attempts (including any errors associated therewith), an infected device may be identified and appropriate action be taken (e.g., continue monitoring, isolate infected device from network, generate call to network help desk, etc.). This approach may be implemented at a network level to help prevent further promulgation of the malicious program to other devices.

### BACKGROUND OF THE INVENTION

1. Technical Field of the Invention

The invention relates generally to network security; and, more particularly, it relates to identifying malware infected devices within such a network.

2. Description of Related Art

Communication systems have been under continual development for many years. Generally speaking, communication systems may also be referred to as networks that allow inter-communication of various communication devices coupled to or capable of coupling to the network. One prominent network is the Internet. The terms network and communication system may be used interchangeably herein.

Networks provide a means by which a great deal amount of communication may be made between devices, users, etc. However, many such networks (e.g., the Internet) are particularly susceptible to infection by hackers that seek to infiltrate various devices or communications within such networks. Sadly, hackers seek to infect devices within such networks for a variety of reasons: personal financial gain, a desire to cause disruption (e.g., gain such nefarious recognition), or for other reasons. Such infections and compromises to a network or the devices therein come in a wide variety of forms including worms, trojans, viruses, malware, spyware, BOTs (or botnets), etc. Of course, the nomenclature of such malicious infections continues to adapt and change as new infections are generated by such hackers and identified by those seeking to stem their promulgation. Generally speaking, such infections are those elements that are introduces by unauthorized users of a network (e.g., a hacker) in an attempt to effectuate some desired end (e.g., disruption, acquire information, etc.).

Typical, prior art means of dealing with such infections is based on establishing a perimeter of defense around an individual device of the network. Since many networks allow virtually anyone to gain access thereto (e.g., the Internet), and given that even users with malicious intent (e.g., hackers) can gain access to such networks just as easily, this perimeter of defense has been the most typical approach in an effort to protect individual devices of the network in an effort to keep that individual device free from infection. This may be generally referred to as an individual device (e.g., desktop, server, etc.) based protection approach.

Today, there are many such products (e.g., available in software to run on various platforms) that perform the various perimeter of defense functions such as firewall, detection of unauthorized program running, anti-virus, anti-spyware, etc. Clearly, though, not all users ensure their device has some such form of protection. Many users simply provide no form of firewall, anti-virus, anti-spyware, etc. Many users will run such anti-virus, anti-spyware, etc. scans using their desired form of protection sufficiently regularly in an effort to identify and hopefully remove such malicious programs; however, such scans are only as effective as the pattern files employed by such anti-virus, anti-spyware, etc. programs. Hackers continually try to update and modify their malicious programs to avoid detection of their malicious programs.

Sometimes, hardware and software product vendors provide some limited form of protection with the purchase of such a hardware or software product. Moreover, many hardware and software product vendors also provide patches and ‘fixes’ to vulnerabilities of their products, yet not all users of those products keep their programs up to date with such patches (and some users are not even aware of such patches). One problem with such prior art approaches to detection and dealing with such problems is that they focus on identification of such malicious programs during the infection stage. As a result, a number of devices are vulnerable to infection by such malicious programs (e.g., malware, botnet, etc.)

As can be seen, prior art approaches to dealing with such malicious programs is an individual device (e.g., desktop, server, etc.) based protection approach. This inherently leaves unprotected devices particularly vulnerable. Other than installing protection mechanisms (e.g., firewalls, anti-virus software, etc.) on each and every device within a network, the prior art currently does not provide an adequate means of protection on a broad basis for protecting other devices within a network from infection.

### BRIEF SUMMARY OF THE INVENTION

Various aspects of the invention may be found in an apparatus that includes a processing module and a memory device. The memory may be integrated with the processing module, or separately implemented and in communication with one another. Such an apparatus may be any device coupled to or capable to interacting with a network (e.g., a server device, a router device, etc.). In certain embodiments, such an apparatus may generally be referred to as a security appliance. The processing module operates by monitoring network messages as they pass to/from various other devices on the network. Particularly, the processing module looks for network messages that have a likelihood of being associated with suspicious behavior (e.g., ICMP network messages indicating destination unreachable). The memory may store predetermined network message types having characteristics that are typically associated with such suspicious behavior (e.g., again, destination unreachable type network messages).

Oftentimes, a device infected with a malicious program (e.g., a malware, botnet, virus, etc.) attempts to perform a call home type communication to an originating device by which the infected device became infected in the first place. When such a communication is attempted, the processing module may then identify the infected device based on one or more network messages associated with such an attempted communication. After identifying the infected device as being infected by some malicious program, any of a number of appropriate actions may be made including re-routing the attempted communication and any future attempted communication from the infected device to a virtual network (e.g., such as by re-assigning the MAC address of the infected device). Alternatively, the attempted communication may be captured for further analysis. The infected device and/or the originating infected device may also be isolated from the network completely to ensure and/or reduce the possibility of other devices being infected.

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a diagram illustrating an embodiment of a malware infected device calling home.

FIG. 2 is a diagram illustrating an embodiment of an enterprise network including a security appliance that identifies a malware infected device and takes appropriate action.

FIG. 3A and FIG. 3B are diagrams illustrating embodiments of malware functionality as a function of time.

FIG. 4 is a diagram illustrating an embodiment of call home and infection promulgation being stopped on a per action basis.

FIG. 5 is a diagram illustrating an embodiment of call home and infection promulgation being stopped by device isolation.

FIG. 6 is a diagram illustrating an embodiment of a method for identifying a malware infected device and taking appropriate action.

### DETAILED DESCRIPTION OF THE INVENTION

As described above, infection of devices within a network by malicious programs continues to be an ever-growing problem. In many instances, a malware infected device attempts to call home or receive calls from another device within the network (e.g., the device by which the infected device became infected in the first place).

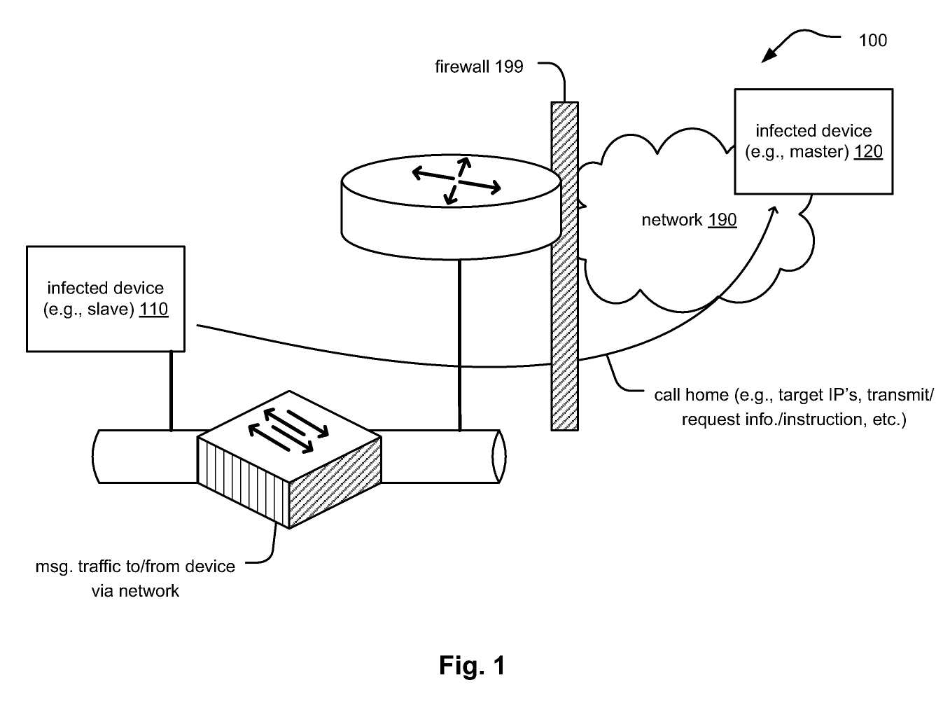

FIG. 1 is a diagram illustrating an embodiment 100 of a malware infected device 110 (e.g., slave) calling home to another infected device 120 (e.g., a master). This attempted call will typically pass through a local network portion, through a firewall 199 (if one is implemented) and then through network 190. Network messages will be associated with this attempted communication.

During this call home process, sometimes vital information about the attack, target, master device, etc. may be transmitted. The call home may include information acquired/retrieved from the infected device, or it may request additional information from the infecting device (e.g., additional malicious code to be transmitted to infect further the already infected device or to go and infect other devices within the network).

If a call home type communication can be captured, information therein can be used to provide intrusion prevention system/intrusion detection system (IPS/IDS) signature to identify the activity on the network and to prevent further promulgation of the malicious program or components thereof. This captured information may also provide information on the originally infecting device (e.g., master device) from which the malicious program originated.

Unfortunately, most of the call home operations occur while a user is completely unaware of offending activity. Sometimes, a malicious program will lie in wait until the occurrence of a particular activity before taking action (e.g., a period of device inactivity with no keystrokes or mouse clicks, when a user accesses a particular web site such as a bank account, etc.). The malicious program can operate during a period of inactivity to perform communication with the originally infecting device (e.g., master device). The malicious program can wait until a user accesses a particular web site and then begin to log keystrokes; then this keystroke log may be transmitted back to the originally infecting device (e.g., master device) to allow a hacker to gain access to a user's private/confidential information. The malicious program may also perform other functions as well.

When such communications are attempted between an infected device (e.g., slave) and its master infecting device, network messages may be generated and associated with those attempted communications. Oftentimes, network messages associated with such attempted communications will indicate error messages such as host unavailable (e.g., the address of the master infecting device is unavailable and/or unauthorized to be accessed). Such host unavailable messages can indicate that such an attempted communication was blocked, dropped, or simply did not reach its destination for some reason. Within networks that employ transmission control protocol/Internet protocol (TCP/IP) protocol suite, Internet control message protocol (ICMP) is employed when errors occur on the network. Such associated network messages (e.g., sometimes showing up as error messages) are associated with communications via the network.

When a communication is attempted between an infected device (e.g., slave) and its master infecting device, network messages are associated with that attempted communication. By monitoring the messages associated with such attempted communications, infected devices can be identified within a network. This approach to performing detection and dealing with infections may be implemented on a network level or network basis. For example, an apparatus (e.g., generally referred to as a security appliance) may be implemented on the network to perform such message monitoring and analysis and to take appropriate actions. Any of a variety of actions may be taken when an infected device is identified. For example, the infected device may be isolated from the network (e.g., by re-addressing the MAC address of the infected device and directing all communication there from to a virtual network), communications to/from the originating infecting device (e.g., master infecting device) may be blocked, communications to/from the infected device may be further monitored, a security appliance can emulate the master infecting device to receive all communications from the infected device to generate a log that may undergo future analysis, etc.

For example, in one instance, an ICMP type 3 message may be generated and sent back to the sending device (e.g., the slave infected device) indicating that the intended destination (e.g., the master infecting device) does not exist. By monitoring for such network messages, and when such a network messages is detected, a process may be started to generate an instance of a dynamic responder. Such a dynamic responder can exist on a switch within a network or as a separate device (e.g., a security appliance) dedicated to such tasks. Alternatively, such functionality could be implemented on an existing device already coupled to or servicing the network. This dynamic responder operation can be generally referred to as a server daemon process in some embodiments. Depending on the type of network message received, the dynamic responder process will take the necessary characters based on the type of network message (e.g., ICMP network message) received.

Various types of ICMP destination hose unavailable network messages may have a code value as follows:

a. Code Value 0 for net unreachable

b. Code Value 1 for host unreachable

c. Code Value 2 for protocol unreachable

d. Code Value 3 for port unreachable

e. Code Value 4 for fragmentation needed and DF set

f. Code Value 5 for source route failed

Any one of these code values may be employed to identify the existence of a malicious program during its attempted communication (e.g., to call home) to the originating infecting device (e.g., master infecting device). When such a network message is captured, a dynamic responder process may be created to establish communication with the malicious program on the infected device.

Once a three-way handshake has been established, the malicious program will perform its function (e.g., either sending retrieved information back to the master infecting device or query for additional information). Regardless of what function the malicious program performs, the dynamic responder process can capture and record such network message for appropriate analysis and the taking of appropriate actions.

For example, the dynamic responder process may terminate the session either gracefully or immediately by sending session resets. The captured data (e.g., within or associated to the captured network message) can then be used by system administrators and others to identify infected/compromised systems and devices on the network.

It is also noted that some legitimate software programs (i.e., user-authorized and non-malicious programs) may perform “phone home” operations that are somewhat similar to the call home functions of malware, but such “phone home” operations are of course for various legitimate reasons such as to obtain software updates, communicate software problems to manufacturer, etc. Sometimes, such “phone home” operations may be blocked by the firewall. Such a failed attempted communication may generate a network message being an ICMP type 3 network message.

Clearly, such legitimate “phone home” operations (e.g., by user-authorized and non-malicious programs) may be easily handled by a “white list” of IP addresses that are known to be legitimate. Occasionally, as new, legitimate software is installed on a device or an IP address associated therewith changes, such updated or now legitimate IP addresses need to be identified. Clearly, a network administrator can decide which new IP addresses, if any, to add to the white list.

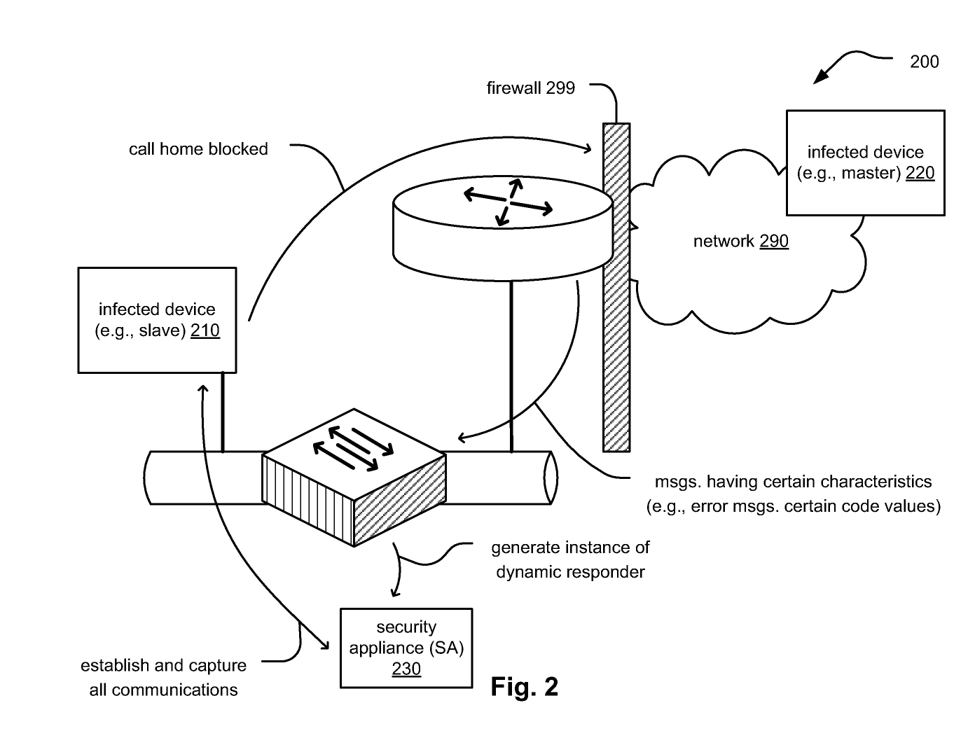

FIG. 2 is a diagram illustrating an embodiment 200 of an enterprise network including a security appliance (SA) 230 that identifies a malware infected device 210 (e.g., a slave) and takes appropriate action. As will be seen, two main components to performing such malware detection and processing include an ICMP snoop for identifying network messages of interest (e.g., Destination Host Unreachable messages) and the dynamic responder process as effectuated by the SA 230.

When an infected device 210 attempts to call home (e.g., to originating infected master device 220), typically an edge router or firewall 299 will drop this attempted communication and generate a network message (e.g., an ICMP error message) that is sent back to the source infected device 210. When this occurs, the ICMP snoop feature being administered by SA 230 may exist in a Layer 2 switch on the network and will immediately generates an instance of the dynamic responder process.

The dynamic responder process may be performed by the SA 230 (e.g., which may be a pre-configured lightweight server) that can identify information requests and respond to them accordingly. Once an initial attempted communication has been identified (e.g., as being a network message type of interest such as having a code value of interest) and the source infected device 210 thereby identified, then the SA 230 can perform any number of desired actions including terminating the data session of source infected device 210 using the SA 230, capturing the attempted communication (e.g., for system administrator use and/or further analysis), re-routing of communications to/from the source infected device 210 to a virtual network (e.g., by modifying the MAC address of the source infected device 210), blocking only selected communications to/from the source infected device 210, isolating the source infected device 210 from network 290, etc.

The SA 230 may include a processing module that monitors one or more network messages corresponding to one or more attempted communications from the source infected device 210 to the originating infected master device 220 (e.g., network messages associated with call home operations).

As also described elsewhere in various embodiments, the SA 230 may also include a memory that stores information corresponding to predetermined network message types such as those associated with suspicious behavior (e.g., unreachable and corresponding code values as identified above). When a network message corresponds to one or more of the predetermined network message types (e.g., such as those associated with suspicious behavior), the processing module (e.g., as within the SA 230) can then perform any one of a variety of functions including re-routing the attempted communication and any future attempted communication from the source infected device 210 to a virtual network. This may be effectuated by re-assigning the MAC address of the source infected device 210 so that all communications are re-routed to a virtual network (e.g., a virtual local area network (LAN)). In such a case, the source infected device 210 can effectively be isolated from the network 290, so that additional devices are not further infected by the source infected device 210, and so that no information retrieved from the source infected device 210 is compromised (e.g., by being transmitted back to the originating infected master device 220).

By identifying infected devices within a network, and by isolating either such an infected device or communications to/from such an infected device, the possibility of promulgation of such an infection throughout a network may be significantly reduced. Moreover, most prior art protection schemes (e.g., anti-virus, anti-spyware, etc.) try to identify the existence of such a malicious program during the infection stage. However, if the infection passes through such a prior art protection scheme undetected, there is typically no way thereafter to stop the malicious program from doing its maliciously intended function. By monitoring the network messages associated with such attempted communications from such a malicious program, an infection can later be identified even if it has already passed though such a prior art protection scheme (that failed to detect it during infection).

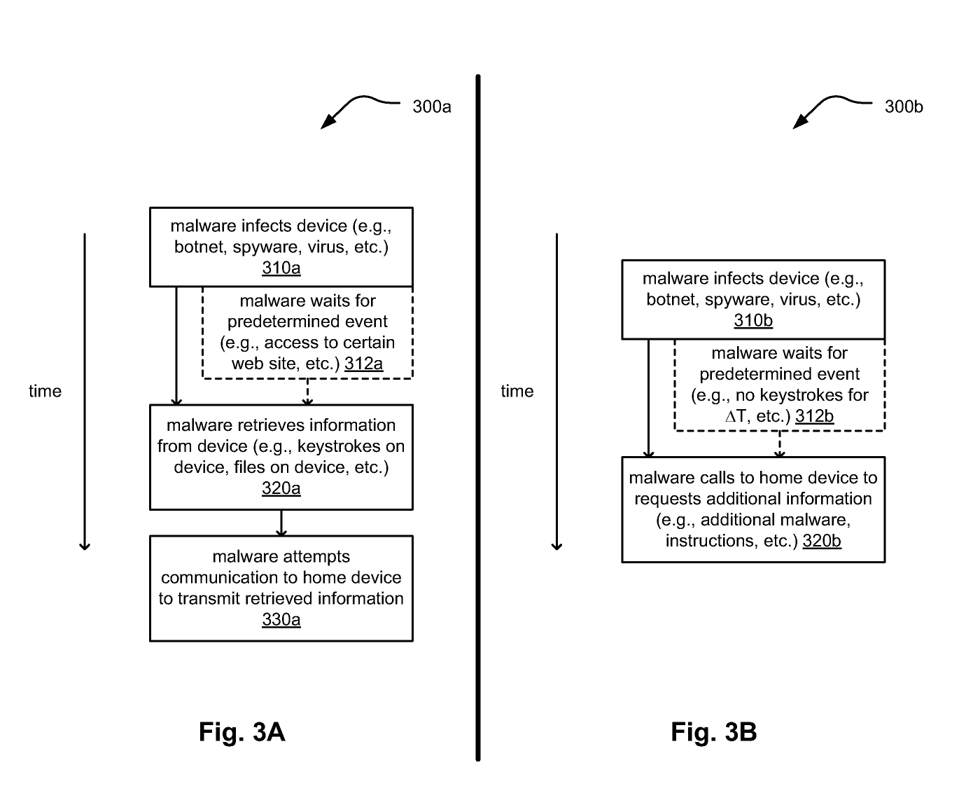

FIG. 3A and FIG. 3B are diagrams illustrating embodiments 300a and 300b, respectively, of malware functionality as a function of time.

Referring to FIG. 3A, a malware initially infects a device (e.g., such a malware maybe a botnet, a spyware, a virus, a trojan, etc.), as shown in a block 310a. In some embodiments, the malware waits until a predetermined event occurs before performing its intended malicious function (e.g., access to a certain web site, etc.) as shown in a block 312a.

The malware then retrieves information from the device as shown in a block 320a. This retrieved information can take a variety of forms including information resident on the device (e.g., personal files on a user's computer), keystrokes made on a computer when a user accesses particular web sites (e.g., a financial account at a bank's web site), etc. The malware on the infected device then attempts communication to a home device to transmit the retrieved information, as shown in a block 330a.

Referring to FIG. 3B, a malware initially infects a device (e.g., such a malware maybe a botnet, a spyware, a virus, a trojan, etc.), as shown in a block 310b. In some embodiments, the malware waits until a predetermined event occurs before performing its intended malicious function (e.g., no keystrokes being made on a computer for a time period (ΔT), etc.) as shown in a block 312a. Then, the malware on the infected device then attempts communication to a home device to request additional information there from (e.g., additional malware to be transmitted back to the infected device, additional instructions such as to infect other devices, etc.), as shown in a block 320b.

Clearly, the depiction of operations of such malware as depicted in these diagrams is not exhaustive, and other operations of such malicious programs may alternatively be performed.

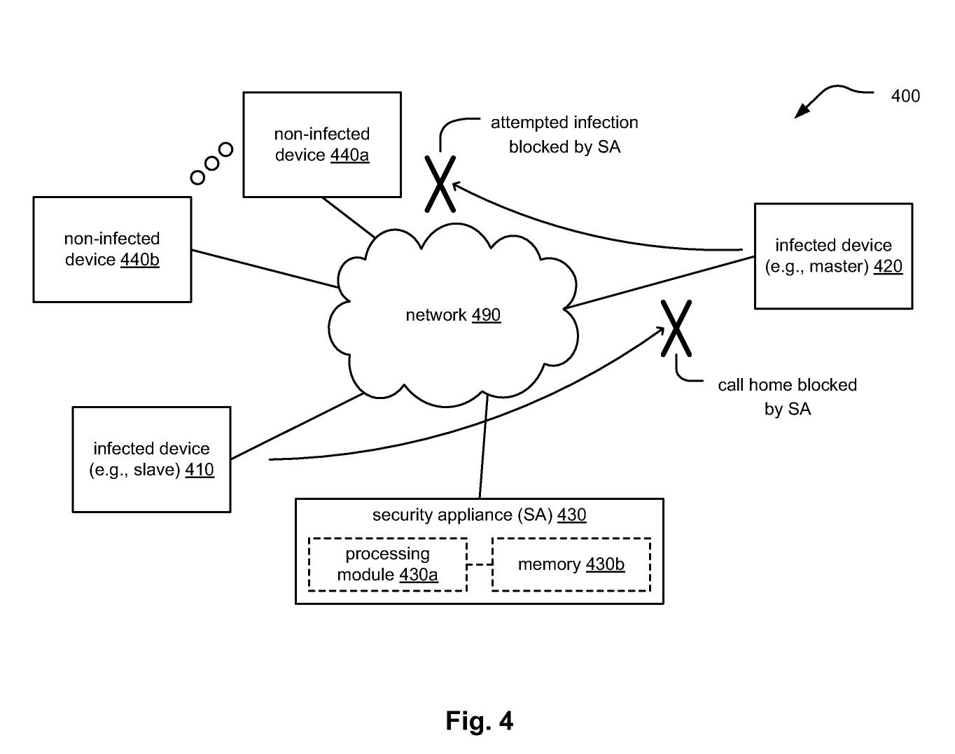

FIG. 4 is a diagram illustrating an embodiment 400 of call home and infection promulgation being stopped on a per action basis. A number of devices are coupled to and can communicate via a network 490. A number of non-infected devices are shown by reference numerals 440a through 440b. An infected device (e.g., master) 420 operates to or has already operated to infect device (e.g., slave) 410. A security appliance (SA) 430, that may include a processing module 430a and a memory 430b, operates by monitoring network messages associated with communications to/from the various devices coupled to the network 490.

In this embodiment 400, the SA 430 operates to block individual communications be each of the infected device (e.g., master) 420 and the infected device (e.g., slave) 410. For example, after identification of infection on the infected device (e.g., slave) 410, a call home from the infected device (e.g., slave) 410 to the infected device (e.g., master) 420 is blocked by the SA 430. Also, since the intended destination associated with the infected device (e.g., master) 420 is now ascertained, attempted infection by the infected device (e.g., master) 420 (as well as by the infected device (e.g., slave) 410, for that matter) may now be blocked by the SA 430.

If desired, not all communications to/from the infected device (e.g., master) 420 and the infected device (e.g., slave) 410 need be blocked, but communications may be blocked on a per communication basis in embodiment 400.

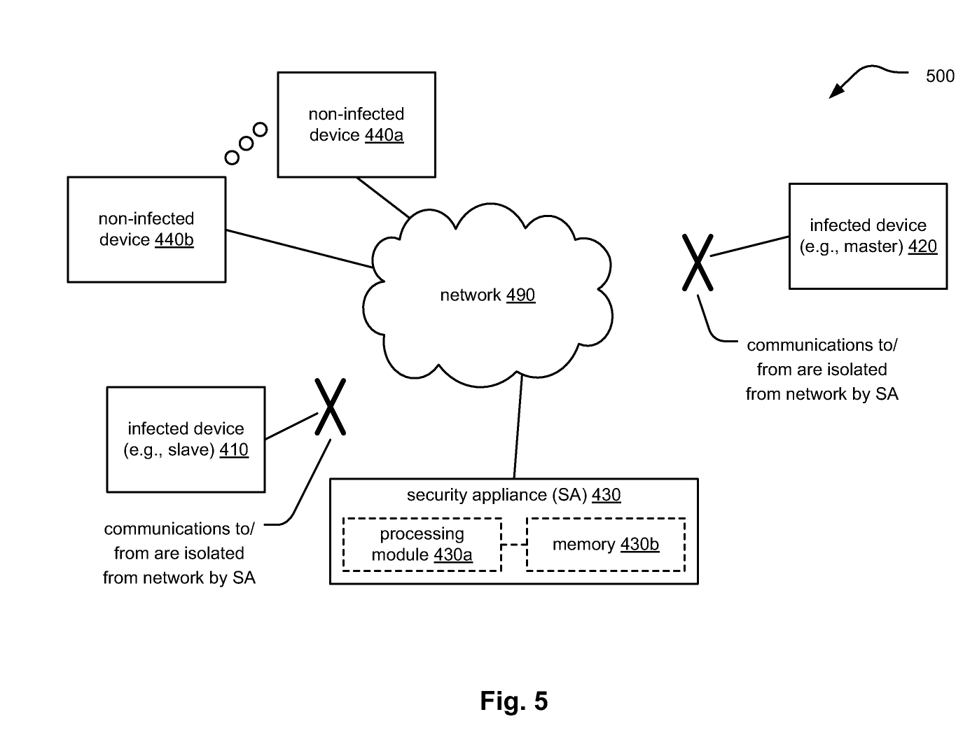

FIG. 5 is a diagram illustrating an embodiment 500 of call home and infection promulgation being stopped by device isolation. This embodiment 500 differs from the previous embodiment, in at least that, all communications to/from each of the infected device (e.g., master) 420 and the infected device (e.g., slave) 410 are now completely blocked. In other words, the infected device (e.g., master) 420 and the infected device (e.g., slave) 410 are now completely isolated from the network 490 by the SA 430.

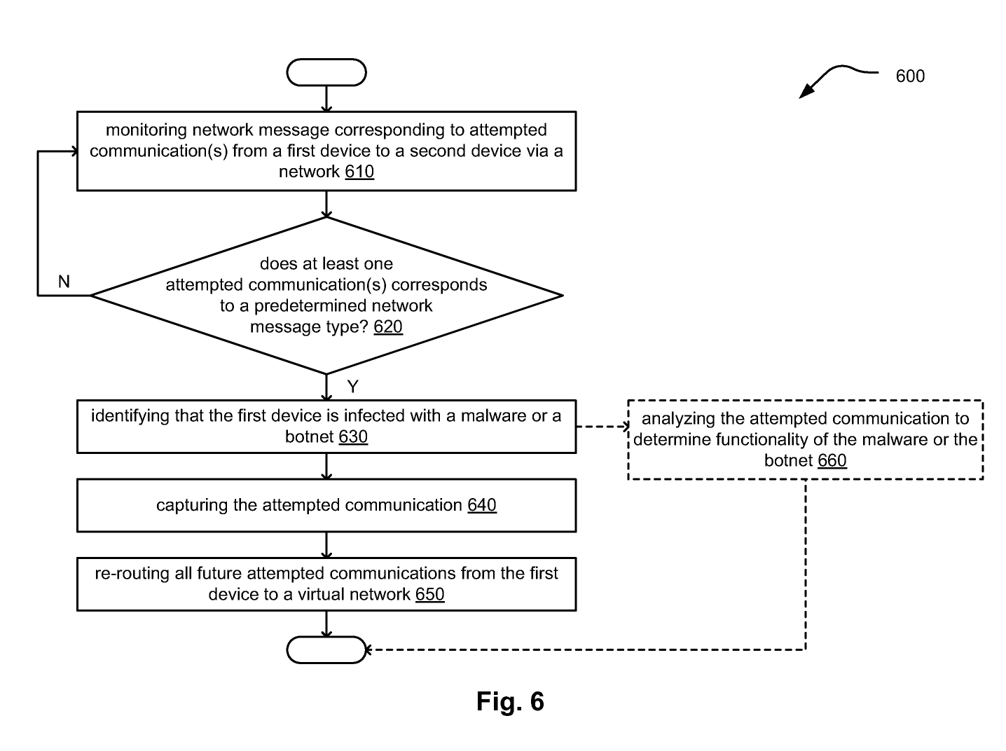

FIG. 6 is a diagram illustrating an embodiment of a method 600 for identifying a malware infected device and taking appropriate action. As shown in a block 610, the method 600 operates by monitoring a plurality of network messages corresponding to at least one attempted communication from a first device to a second device via a network. Then, the method 600 operates by determining whether or not at least one of the attempted communications corresponds to a particular network message type, as shown in a block 620. A particular network message type may be a destination unreachable type error network message in some embodiments. If the network message does not correspond to a particular network message type that is indicative of some suspicious behavior, then the method 600 continues the operation of block 610.

Alternatively, if the network message does correspond to a particular network message type that is indicative of some suspicious behavior, then the method 600 operates by identifying that the first device is infected with a malware or a botnet (or some other malicious program), as shown in a block 630. In some embodiments, the method can then operate by analyzing the attempted communication to determine functionality of the malware or the botnet, as shown in a block 660.

in another embodiment, after performing the function of block 630, the method 600 operates by capturing the attempted communication, as shown in a block 640, and by re-routing all future attempted communications from the first device to a virtual network, as shown in a block 650.

In addition, other operations may be performed when an infected device or system is identified as described within other embodiments herein (e.g., continuing to monitor network message to/from a suspected infected device, emulating the originating infected device to capture all future call home attempts, etc.).

It is noted that the various modules (e.g., processing modules, devices, security appliances, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus, comprising:
a memory, implemented to store a plurality of predetermined network message types; and
a processing module that monitors a network message corresponding to an attempted communication from a first device to a second device via a network; and wherein:
when the network message corresponds to at least one of the plurality of predetermined network message types, the processing module re-routes at least one of the attempted communication and a future attempted communication from the first device to a virtual network.

2. The apparatus of claim 1, wherein:
the network message corresponding to the attempted communication is one of a plurality of network messages corresponding to a plurality of attempted communications of the first device;
based on the plurality of network messages, the processing module identifies that the first device is infected with a malware or a botnet; and
when the first device attempts the communication to a second device, the processing module captures the attempted communication.

3. The apparatus of claim 2, wherein:
the attempted communication includes information retrieved from the first device by the malware or the botnet.

4. The apparatus of claim 2, wherein:
the attempted communication includes a request, made by the malware or the botnet, for additional information from the second device.

5. The apparatus of claim 1, wherein:
when the network message corresponds to the at least one of the plurality of predetermined network message types, the processing module emulates the second device.

6. The apparatus of claim 1, wherein:
when the network message corresponds to the at least one of the plurality of predetermined network message types, the processing module isolates the first device from the network.

7. The apparatus of claim 1, wherein:
the processing module monitors a plurality of network messages corresponding to a plurality of attempted communications from the first device to the second device via the network;
when a number of the plurality of network messages match at least one of the plurality of predetermined network message types, the processing module:
identifies that the first device is infected with a malware or a botnet; and
isolates the first device from the network.

8. The apparatus of claim 1, wherein:
the network message is an error message indicating that the second device is unreachable by the first device via the network.

9. The apparatus of claim 1, wherein:
when the network message corresponds to at least one of the plurality of predetermined network message types, the processing module:
identifies that the first device is infected with a malware or a botnet;
captures the attempted communication;
analyzes the attempted communication to determine functionality of the malware or the botnet.

10. The apparatus of claim 1, wherein:
the first device is a malware or a botnet infected slave device; and
the second device is a malware or a botnet infected master device.

11. An apparatus, comprising:
a memory, implemented to store a plurality of predetermined network message types; and
a processing module that monitors a plurality of network messages corresponding to a plurality of attempted communications from a first device to a second device via a network; and wherein:
when a predetermined number of the plurality of network messages corresponds to at least one of the plurality of predetermined network message types, the processing module:
identifies that the first device is infected with a malware or a botnet;
captures the attempted communication;
isolates the first device from the network; and
analyzes the attempted communication to determine functionality of the malware or the botnet.

12. The apparatus of claim 11, wherein:
the attempted communication includes information retrieved from the first device by the malware or the botnet.

13. The apparatus of claim 11, wherein:
the attempted communication includes a request, made by the malware or the botnet, for additional information from the second device.

14. The apparatus of claim 11, wherein:
at least one of the plurality of network messages is an error message indicating that the second device is unreachable by the first device via the network.

15. The apparatus of claim 11, wherein:
the first device is a malware or a botnet infected slave device; and
the second device is a malware or a botnet infected master device.

16. A method, comprising:
monitoring a plurality of network messages corresponding to a plurality of attempted communications from a first device to a second device via a network;
when a predetermined number of the plurality of network messages corresponds to at least one of the plurality of predetermined network message types:
identifying that the first device is infected with a malware or a botnet;
capturing the attempted communication; and
re-routing all future attempted communications from the first device to a virtual network.

17. The method of claim 16, further comprising:
analyzing the attempted communication to determine functionality of the malware or the botnet.

18. The method of claim 16, wherein:
the attempted communication includes information retrieved from the first device by the malware or the botnet.

19. The method of claim 16, wherein:
at least one of the plurality of network messages is an error message indicating that the second device is unreachable by the first device via the network.

20. The method of claim 16, wherein:
the first device is a malware or a botnet infected slave device; and
the second device is a malware or a botnet infected master device.
